(19) United States
(12) Patent Application Publication
(10) Pub. No.: US 2025/0049536 A1
(43) Pub. Date: Feb. 13, 2025

(54) DENTAL TOOL

(71) Applicant: Alexander Dental Group, Placentia, CA (US)

(72) Inventors: Vigen ALEXANDER, Northbridge, CA (US); Arvin Alexander, Northbridge, CA (US); Arin Alexander, Northbridge, CA (US)

(21) Appl. No.: 18/921,981

(22) Filed: Oct. 21, 2024

Related U.S. Application Data
(63) Continuation-in-part of application No. PCT/US23/19302, filed on Apr. 20, 2023.
(60) Provisional application No. 63/333,027, filed on Apr. 20, 2022.

(51) Int. Cl. A61C 5/46

(52) U.S. Cl. CPC A61C 5/46

(57) ABSTRACT

A device includes a housing and a charge storage device coupled to the housing. The charge storage device includes a first terminal and a second terminal and is configured to store an electrical charge. The device includes a retrieval tip, including a first electrode electrically connected to the first terminal of the charge storage device, a second electrode connected to the second terminal of the charge storage device, and an insulator disposed between the first electrode and the second electrode. The insulator is configured to inhibit a flow of electricity directly between the first electrode and the second electrode and when a distal end of the retrieval tip is positioned in proximity to a conductive object, the electrical charge is discharged between the first electrode and the second electrode through the conductive object.

### CROSS REFERENCE TO RELATED APPLICATIONS

This application is a continuation-in-part of the pending International Application No. PCT/US23/19302 filed on Apr. 20, 2023, which claims the benefit of U.S. Provisional Patent Application No. 63/333,027, filed on Apr. 20, 2022, the contents of which are all incorporated herein by reference in their entireties.

### TECHNICAL FIELD

The present invention generally relates to a device configured for the retrieval of metal components and, specifically, to a device configured to utilize a metal joining process initiated by electrical arc for the retrieval of metal components and materials.

### BACKGROUND OF THE INVENTION

In some procedures, such as medical or dental procedures, metal components or pieces of such components may become lodged or stuck with a patient undergoing the procedure. This can result in complications to the procedure and potential health complications for the patient. For example, in a dental procedure calling for a root canal, the drill bit or file being using to form an opening or channel into and through the tooth's enamel and inner pulp can be quite delicate and can sometimes break. If the tip of such a drill bit or file breaks within the tooth, it can be very difficult to retrieve the broken tip. If the tip were to be left in place, the root canal procedure cannot proceed, and potential complications may result. As such, additional procedures and/or surgeries may be required to retrieve the broken tip. Such additional procedures required to retrieve such metal components or devices add significant complexity to the original procedure and may result in further complications for the patient.

These types of issues and problems can occur in many different types of dental and other medical procedures that involve the use of fine or delicate metal components and devices.

Accordingly, there is a need for devices and methods to facilitate the retrieval of metal components that may become lodged within a patient during a procedure. And, in a specific use case, there is a need for devices and methods to facilitate the retrieval of broken drill bit or file tips that may become lodged within a patient's tooth during dental procedures, such as root canals.

### BRIEF DESCRIPTION OF THE FIGURES

A more complete understanding of the subject matter may be derived by referring to the detailed description and claims when considered in conjunction with the following figures, wherein like reference numbers refer to similar elements throughout the figures.

FIG. 1 depicts a device in accordance with the present disclosure.

FIG. 2 is an enlarged view of a retrieval tip of FIG. 1 showing additional detail.

FIGS. 3A-3C depicts steps in the process of adhering the distal end of a retrieval tip to the metal object.

FIG. 4A shows additional detail of example geometries of an embodiment of retrieval tip 120.

FIG. 4B is a cross-sectional view of the retrieval tip of FIG. 4A taken along line 4B-4B.

FIGS. 5A-5C depicts various steps in the process of using the present device for retrieval of a broken drill bit during a dental procedure.

FIG. 6 depicts a charging station and power cable usable in conjunction with the present invention.

FIG. 7 is a circuit diagram depicting a control system of the present retrieval device.

FIG. 8 is a block diagram depicting function components of the present device.

FIGS. 9-10 depict an alternate embodiment of a dental device configured in accordance with the present disclosure.

FIGS. 11-12 depict a retrieval tip of a dental tool.

FIG. 13 depicts an electrical power system that may be used in conjunction with the dental device of FIGS. 9-10.

### DETAILED DESCRIPTION

The following description recites various aspects and embodiments of the invention disclosed herein. No particular embodiment is intended to define the scope of the invention. Rather, the embodiments provide non-limiting examples of various configurations, and methods that are included within the scope of the claimed invention. The description is to be read from the perspective of one of ordinary skill in the art. Therefore, information that is well known to the ordinarily skilled artisan is not necessarily included.

The present invention is directed to a device configured to facilitate the retrieval of metal components or devices (or portions thereof) that may become lodged or otherwise disposed within a patient during a medical or dental procedure. The device includes a narrow probe configured to be introduced into the region of the patient in which the metal component is located. The device's probe includes a retrieval tip that is configured to discharge an electrical potential that generates an electrical arc through the metal component. The arc is configured to form a weld, brazing, or physical connection between the retrieval tip and the metal component thereby affixing the retrieval tip to the metal component allowing removing of the metal component. In alternative embodiments, the arc is configured form a brazed joint or other form of physical connection between the retrieval tip and the metal component allowing removing or withdrawal of the metal component.

To use the device, the probe is introduced into the patient so that the retrieval tip is placed in physical contact or proximity to the metal components. With the probe and retrieval tip so positioned, the electrical potential is discharged through the retrieval tip (and the metal component). The resulting electrical arc causes a portion of the probe's retrieval tip to become welded or brazed to the metal component. With the joint formed, the probe, in combination with the attached metal component, can be withdrawn from the patient's body to effect removal of the metal component therefrom.

In a specific use case of the present device in which a patient is undergoing a root canal therapy, the tip of the drill bit being used in the procedure may break off and become lodged within the tooth. If the tip of the drill bit is not removed, the patient may experience significant health complications. Although some conventional approaches exist for the removal of such a broken drill bit do exist, such approaches tend to be ineffective or very invasive. For example, attempts to retrieve the broken drill bit via flushing of the tooth canal or attempting to capture the broken bit using a second drill bit tend to be ineffective and are rarely successful. Conversely, approaches to retrieve the drill bit that involve widening of the original canal space by creating a platform which involved removing coronal tooth structure, or accessing the affected root tip via an opening formed in the patient's gums, referred to as periapical surgery, can be very invasive and require additional surgical procedures.

To mitigate these problems with conventional approaches with retrieving broken drill bits during root canal procedures, the present device can provide for a more effective and less invasive retrieval of metal components or broken portions thereof. Specifically, the probe of the present device, which can have a cross-sectional area equal to or less than that of drill bits commonly used in root canal procedures can be introduced into the channel that was formed by the broken drill bit. The probe is introduced into the tool until the retrieval tip of the device's probe is in physical contact with or in close proximity to the broken drill bit tip. At that time an electrical potential is discharged through the probe's retrieval tip to generate an electrical arc through the broken drill bit tip. The electric arc is configured to cause joint formation that joins the retrieval tip of the device's probe to the broken drill bit tip. With the probe physically attached to the broken drill bit tip by the joint, the probe can be withdrawn from the patient's tooth thereby also removing the broken drill bit tip. The probe may be physically attached to the broken drill bit tip (i.e., fixed to a point of contact), or the broken drill bit tip may be attached to a wired lead of the probe.

In this manner, the present device and method can provide effective and non-invasive retrieval of broken dental drill bit or file tips potentially helping patients avoid costly and invasive follow-up procedures in order to retrieve the broken drill bit tip. In other applications of the device, the device may be used for the removal of metal filling material deposited during a root canal retreatment procedure. Such materials are referred as “silver points” and “metal carriers”. During the retreatment procedure, these metal points can become corroded and/or become lodged in the canal. The process of removing such filling materials is similar to removing broken drill bits/files, thus this device came be also used to free root canal systems from such impediments.

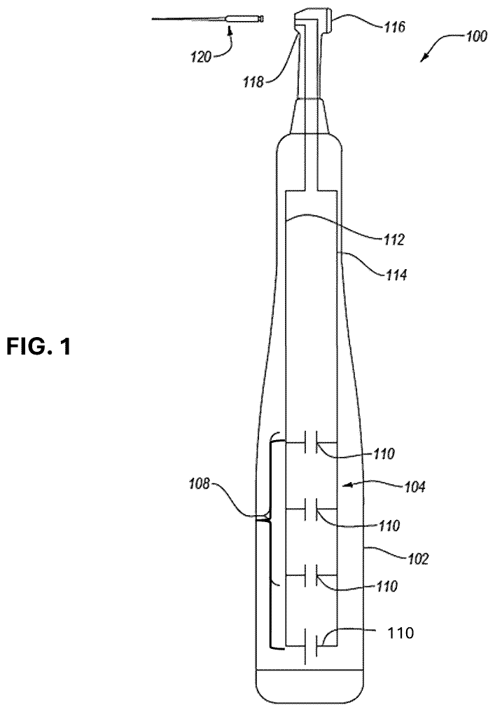

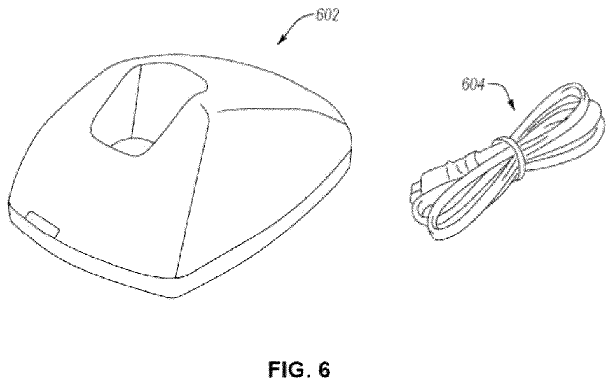

FIG. 1 depicts a device 100 in accordance with the present disclosure. Device 100 includes a housing 102, where housing 102 is configured to enable device 100 to be handheld thereby facilitating operation and positioning of device 100 during a procedure. Device 100 includes an electrical power system 104 that may be housed within housing 102 or external to housing 102. In an embodiment, electrical power system 104 may be coupled to an external power source (not shown) configured to generate an electrical potential usable by device 100. If implemented within device 100, electrical power system 104 may be coupled to an external charging system (e.g., a capacitor charge bank) configured to enable the power source to generate an output signal in a range of about 5 volts of direct current (VDC) at 4 amps (A) to 5 volts (V) at 3 amps (A) with a pulsed waveform. In other embodiments of device 100 different power sources may be utilized, such as power sources that are internal to device 100 housing 102, such as a battery. If device 100 were to be utilized as a handheld battery powered device, device 100 may be used in conjunction with a charging or power station (e.g., charging station 602 of FIG. 6) to which device 100 may be coupled (e.g., via a wired connection). Charge station 602 may itself be powered by an electrical cable 604 (see FIG. 6). In still other embodiments, electrical cable 604 may be plugged directly into device 100 to provide electrical energy thereto.

Charge storage device 108, which may be internal to device 100 (as illustrated in FIG. 1) or external to device 100, may be configured to discharge electrical energy stored therein at a faster rate (e.g., at a higher amperage) than energy discharged our output by an external power source. In an embodiment, charge storage device 108 may comprise a number of capacitors 110 that are each connected in parallel. Specifically, in the configuration depicted in FIG. 1, first terminals of each capacitor 110 can be connected to a first (e.g., positive) terminal of a power source and second terminals of each capacitor 110 can be connected to a second (e.g., negative) terminal of a power source.

The capacitance of the various capacitors 110 may be selected based upon the desired application of device 100, but in an example embodiment, capacitors 110 may each be 1,000 microFarad (μm) capacitors. In other embodiments, different numbers of capacitors 110 having different capacities and different electrical interconnect topologies may be utilized.

The first terminals of charge storage device 108 are connected to a first electrical lead 112 that extends along a length of housing 102. The second terminals of charge storage device 108 are connected to a second electrical lead 114 that extends along a length of housing 102.

A distal end 116 of housing 102 of device 100 includes a socket 118 configured to removably couple to retrieval tip 120. The socket 118 can be indexed to be only capable of receiving retrieval tip 120 in a predetermined and controlled orientation to ensure proper establishment of electrical connections between retrieval tip 120 and socket 118. Second electrical lead 114 and distal end 116 are integrated into socket 118 so that when retrieval tip 120 is coupled to socket 118, portions of retrieval tip 120 are electrically connected to leads 112 and 114, as described herein. In an embodiment, device 100 may include a control switch configured to selectively electrically connect or disconnect charge storage device 108 (e.g., internal to device 100, as shown in FIG. 1, or external to device 100) from the retrieval tip 120 to inhibit a flow of electricity directly between anode 124 (a first electrode) and cathode 126 (a second electrode) of retrieval tip 120. Using the switch, a practitioner can cause the retrieval tip 120 to be electrically disconnected from charge storage device 108 until the retrieval tip 120 is in proximity to the metal object (e.g., broken drill bit) to be retrieved. At that time the control switch can be activated to electrically connect the retrieval tip 120 to charge storage device 108. At that time, electrical energy will be discharged from charge storage device 108 through the retrieval tip 120 and any metal element thereby. In embodiments, charge storage device 108 may be configured to deliver that discharge in the form of a pulse width modulated (PWM) signal having a total time duration of between 1 and 2 seconds (e.g., 1.5 seconds) and frequencies between 100 Hertz and 100 Hertz, for example.

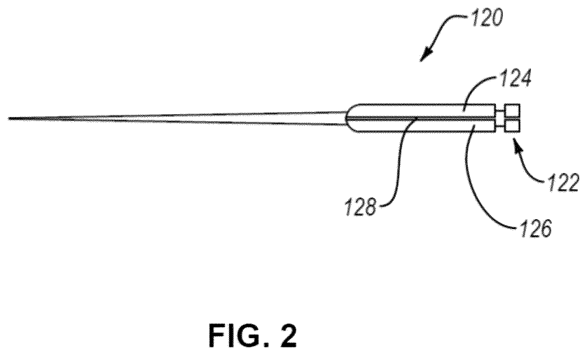

FIG. 2 is an enlarged view of retrieval tip 120 of FIG. 1 showing additional detail. Retrieval tip 120 includes plug 122 configured to engage with socket 118 of housing 102 of device 100. Retrieval tip 120 includes anode 124 and cathode 126 (each one of the anode 124 and the cathode 126 may be referred to as electrodes). In some embodiments, anode 124 and cathode 126 may each include dissimilar metal or other electrically conductive materials. Example materials can include nickel titanium (NiTINOL) and copper. Alternatively, embodiments of device 100 may be implemented in which each of anode 124 and cathode 126 include the same metal or conductive materials. Example materials can include copper, which provides relatively high conductivity and can generate welds or brazing with relatively high success and tensile strength. Anode 124 is separated from cathode 126 by insulator 128 that is physically disposed between anode 124 and cathode 126. Insulator 128 may include a varnish material disposed between anode 124 and cathode 126 or may coat an interior surface of anode 124 and/or cathode 126. If insulator 128 is a varnish material, it may comprise an abrasion- and wear-resistant coating, such as those commonly formed on motor winding wires, transformer wires, and other metal electrical parts to protect them from oils, chemicals, and moisture. Such insulators are solvent based and may be selected to achieve a desired dielectric property. Other suitable materials for insulator 128 may include plastics, or other non-conductive materials suitable for disposing between and/or over a surface of one or more of anode 124 and cathode 126.

When retrieval tip 120 is connected to socket 118 via plug 122, anode 124 is put into electrical connection with the positive terminal of charge storage device 108 and cathode 126 is put into electrical connection with the negative terminal of charge storage device 108. Consequently, when retrieval tip 120 is connected to socket 118 and charge storage device 108 is charged, an electrical potential exists across anode 124 and cathode 126. Because insulator 128 separates anode 124 and cathode 126 the electrical potential does not naturally discharge. However, when a metal object (e.g., a broken dental drill bit or file) is positioned near the distal end of retrieval tip 120 the metal object allows the electric potential across anode 124 and cathode 126 to discharge (e.g., by discharging the capacitors 110 of charge storage device 108) and resulting in an electrical arc being formed. The electrical arc causes at least a portion of the anode 124, cathode 126, and/or the metal object to liquify causing the metal object to adhere to anode 124 and/or cathode 126 (.g., via brazing). With the metal object adhering to anode 124 and/or cathode 126, retrieval tip 120 can be withdrawn, thereby also extracting or removing the metal object.

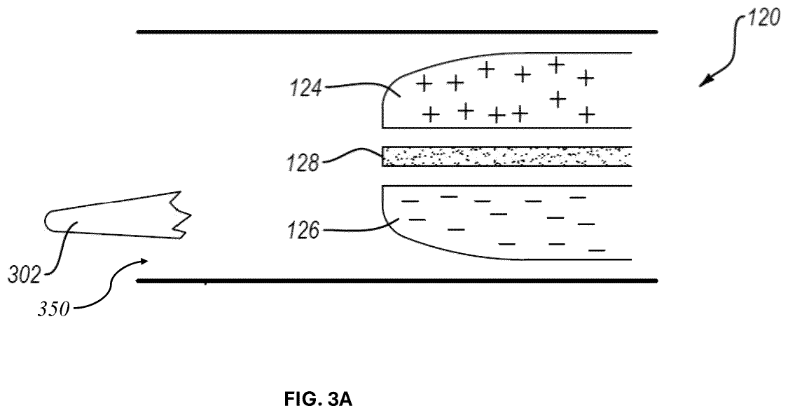

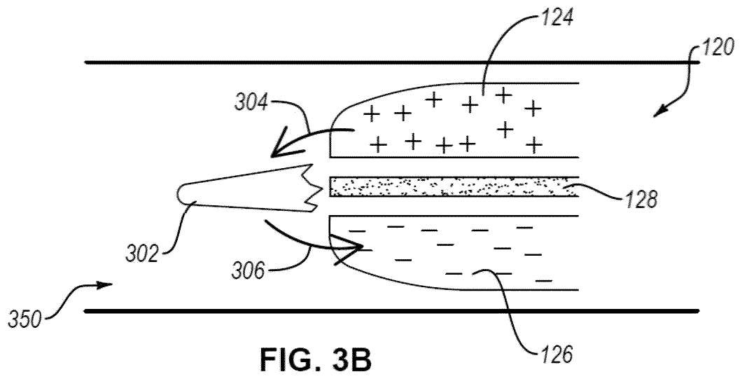

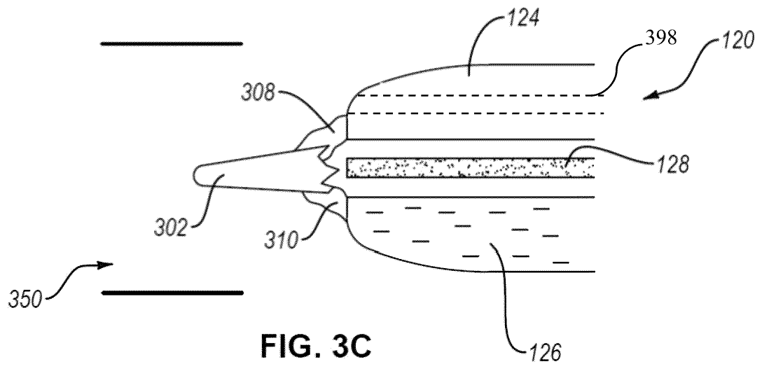

FIGS. 3A-3C depicts steps in the process of adhering the distal end of retrieval tip 120 to a metal object. In an initial step of the process depicted in FIG. 3A, retrieval tip 120 is connected to socket 118 so that an electrical potential exists across anode 124 and cathode 126 (as indicated by the ‘+’ and ‘-’ symbols in anode 124 and cathode 126, respectively). That electrical potential cannot discharge because anode 124 is separated from cathode 126 by insulator 128. Before insertion of the device into the tooth root canal channel 350 the channel may be flushed with EDTA (Ethylenediaminetetraacetic acid, which is a Calcium chelating agent), which can be used to remove tooth debris after drilling. The channel may then be allowed to dry before insertion of the retrieval tip 120 of device 100.

However, in the step depicted in FIG. 3B, the distal end of retrieval tip 120 has been brought into close proximity with metal object 302 (e.g., a broken drill bit tip) in the interior volume of a tooth. In that arrangement, metal object 302 provides a conductive path between anode 124 and cathode 126 resulting in the creation of an electrical arc (indicated by arrows 304 and 306) to be formed as charge storage device 108 discharges through the conductive path formed by anode 124, metal object 302, and cathode 126.

The electric arc results in the distal end of retrieval tip 120 and metal object 302 to heat up rapidly as the electrical energy discharge resulting in a portion of anode 124, cathode 126, and/or metal object 302 to liquify allowing a physical joint to be formed between metal object 302 and anode 124 and/or cathode 126. This is illustrated in FIG. 3C in which the retrieval tip 120 is depicted after the electrical arc has finished discharging (so there is no electrical potential across anode 124 and cathode 126) and metal object 302 is coupled to anode 124 by weld or brazing joint 308 and to cathode 126 by joint 310. In forming a physical joint between metal object 302 and anode 124 and/or cathode 126, a shielding gas can be used to protect the molten puddle from atmospheric contaminants. Without a shielding gas, the physical joint may be defective and porous (e.g., porosity in the joint) or otherwise slightly less effective. A shielding gas to be used may be, for example, Argon (Ar), Carbon Dioxide (CO₂), or a range of a mixture of Ar/CO₂ (e.g., between 75% Ar/25% CO₂, 80% Ar/20% CO₂, 85% Ar/15% CO₂, 90% Ar/10% CO₂, 95% Ar/5% CO₂, and 99% Ar/1% CO₂). In various embodiments a hose 398 may be incorporated into the retrieval tip 120 enabling the shielding gas to be fed into the interior volume of the tooth in which metal object 302 is disposed.

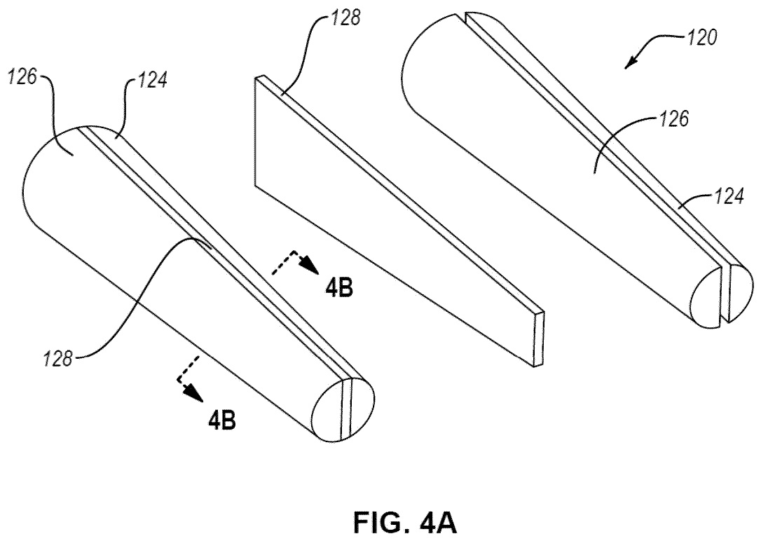

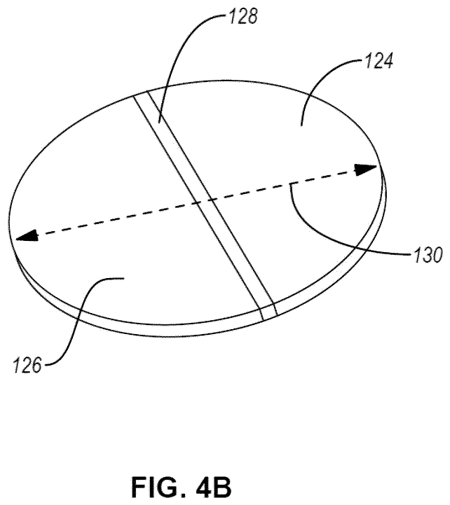

FIG. 4A shows additional detail of example geometries of an embodiment of retrieval tip 120, cathode 126 and anode 124. As shown, in an embodiment, a width or diameter of the cathode 126 and anode 124 of the distal end of retrieval tip 120 (see dashed line 130 of FIG. 4B) may range from 0.2 millimeters (mm) to 0.6 mm, although other embodiments of the cathode 126 and anode 124 of the retrieval tip 120 may be configured with different geometries. For example, cathode 126/anode 124 of retrieval tip 120 may have a tapered geometry that may mimic or be similar to the tapered geometry of a typical dental drill bit. For example, if a 0.04 taper drill bit has broken within a tooth canal and is being retrieved, a cathode 126/anode 124 of a retrieval tip 120 having the same 0.04 taper can be used for retrieval because the canal opening would be too small for a larger (e.g., 0.06 taper) retrieval tip. In specific embodiments, device 100, for example, a number of different cathode 126/anode 124 retrieval tip 120 configurations may be provided where the various retrieval tips 120 each have dimensions similar to those of commonly used dental drill bits. As such, for a particular procedure, if a drill bit should break off, an appropriately sized retrieval tip 120 may be selected for introduction into the hole formed by the broken drill bit.

FIG. 4B is a cross-sectional view of the retrieval tip 120 of FIG. 4A taken along line 4B-4B. As shown in FIG. 4B, retrieval tip 120 may have a generally circular cross-section, though in other embodiments retrieval tip 120 may different cross-section shapes.

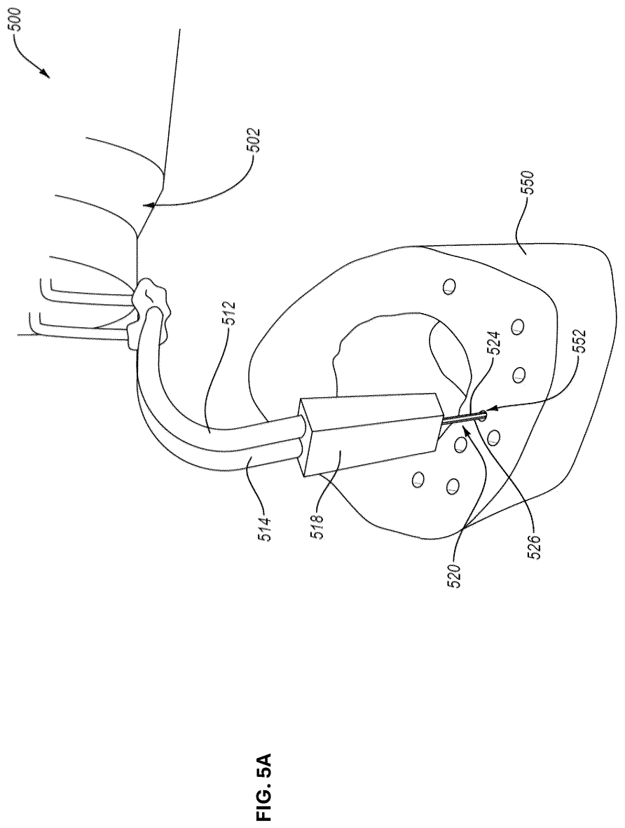

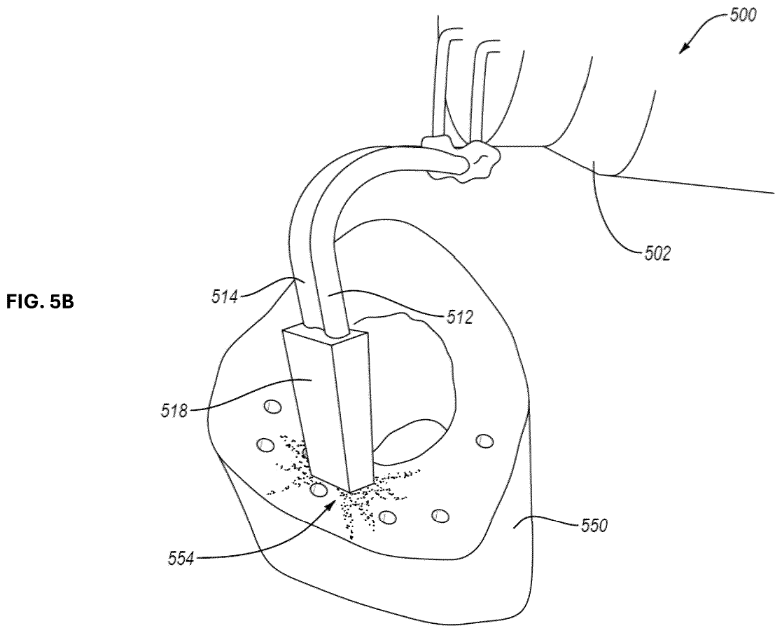

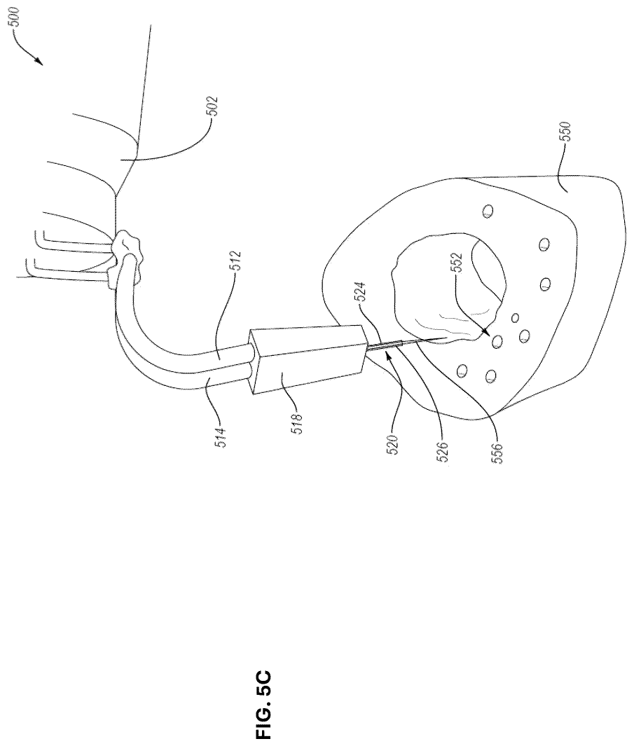

FIGS. 5A-5C depicts various steps in the process of using the present device for retrieval of a broken drill bit during a dental procedure. As illustrated in FIG. 5A, device 500 (e.g., device 100), includes a body 502 (e.g., housing 102) that includes a power source (e.g., a power source and/or charge storage device 108), not shown, coupled to first and second electrical conductors 512, 514 (e.g., first electrical lead 112 and second electrical lead 114). Device 500 includes a socket 518 (e.g., socket 118) configured to couple to retrieval tip 520 (e.g., retrieval tip 120) that includes an anode 524 (e.g., anode 124) and a cathode 526 (e.g., cathode 126). Anode 524 and cathode 526 are separated by an insulator that may comprise a solid structure or the air between anode 524 and cathode 526.

As shown in FIG. 5A, device 500 is being used to perform a procedure on a tooth analog 550, which is representative of a tooth on which a dental procedure may be formed. Tooth analog 550 includes a hole 552 that may have been formed by a drill bit being operated to form hole 552. In this example use case, a portion of the drill bit is broken off and is lodged or disposed within hole 552.

An electric potential is formed across anode 524 and cathode 526 by the power source coupled to first and second electrical conductors 512. During use, tip 520 is introduced into hole 522 until the tip of retrieval tip 520 comes into contact (or sufficiently close proximity) to allow formation of an electrical arc that causes the electrical potential across anode 524 and cathode 526 to be discharged. This is illustrated in FIG. 5B by the electric arc 554.

As described herein, the electric arc 554 causes the broken drill bit to become attached to tip 520 allowing tip 520 and the broken drill bit to be withdrawn from hole 552 of tooth analog 550. This is illustrated in FIG. 5C in which tip 520 has been removed from hole 552 along with the broken portion 556 of the drill bit.

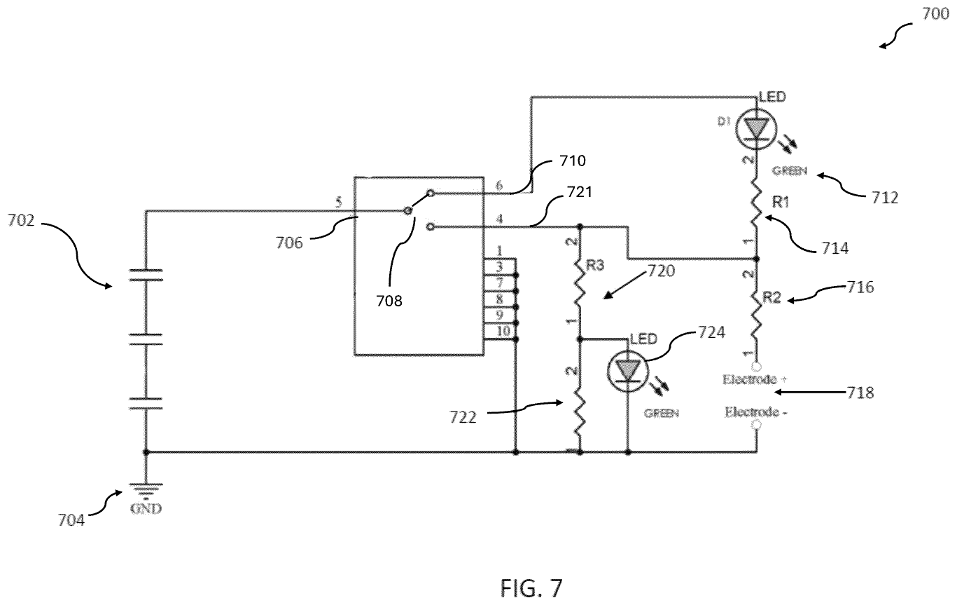

FIG. 7 is a schematic depicting an example control system 700 for the present device. System 700 includes capacitor bank 702 that operates as a charge storage device (e.g., charge storage device 108 of FIG. 1) that may include any number of capacitors (in the depicted example, three capacitors are shown) or other charge storage devices or other devices configured to supply electrical energy that may be located within the hand held portion of the present device or may be external to the device. Capacitor bank 702 or other electrical energy supply source is connected between ground node 704 and input terminal 706 of switch 708. In a default state (i.e., with a corresponding mechanical switch interface not depressed), input terminal 706 is connected to output terminal 710. In this configuration the electrical potential stored across capacitor bank 702 is placed across the series-connected combination of user interface element 712 (e.g., which may include a light emitting diode (LED)), resistor 714, resistor 716, electrode tip 718 (e.g., retrieval tip 120 of FIGS. 1, 2, 3A-3C, and FIGS. 4A-4B), which includes two electrodes separated by a small air gap. In this configuration, if capacitor bank 702 is adequately charged with an appropriate electrical potential, user interface element 712 will generate an output (e.g., if user interface element 712 is an LED, the LED will illuminate) if the electrodes of electrode tip 718 are placed in contact with a metallic object, such as a broken portion of a dental drill bit. As such, user interface element 712 can provide a practitioner will clear feedback indicating that that tool is properly positioned and that, if the tool is discharged, there is a high likelihood that an appropriate connection will be formed with the broken drill bit enabled retrieval thereof.

In this configuration, resistor 714 operates as a current-limiting resistor to prevent full discharge of the electrical potential of capacitor bank 702 through the metallic object.

When the practitioner is ready to operate the tool (i.e., by causing discharge of the electrical potential of capacitor bank 702, the practitioner operates the discharge button causing switch 708 to change states and connecting input terminal 706 to output terminal 721.

In this configuration, the electrical potential of capacitor bank 702 is put across two parallel circuit paths. The first path includes resistor 720 connected in series to resistor 722 and user interface element 724, which are both connected in parallel between resistor 720 and ground node 704.

In this configuration, resistor 720 and 722 operates as a voltage device to provide a predetermined voltage across user interface element 724. When user interface element 724 is an LED the LED illuminates to notify the practitioner that the device is ready for use.

The second circuit path includes resistor 716 and electrode tip 718. In this configuration, if electrode tip 718 is positioned in proximity to a metallic object, the full potential of capacitor bank 702 is discharged through resistor 716, which operates as a current limiting resistor, through electrode tip 718 to cause an electrical discharge configured to securely connect the metal object (i.e., a broken dental drill bit) to electrode tip 718 enabling the object to be withdrawn.

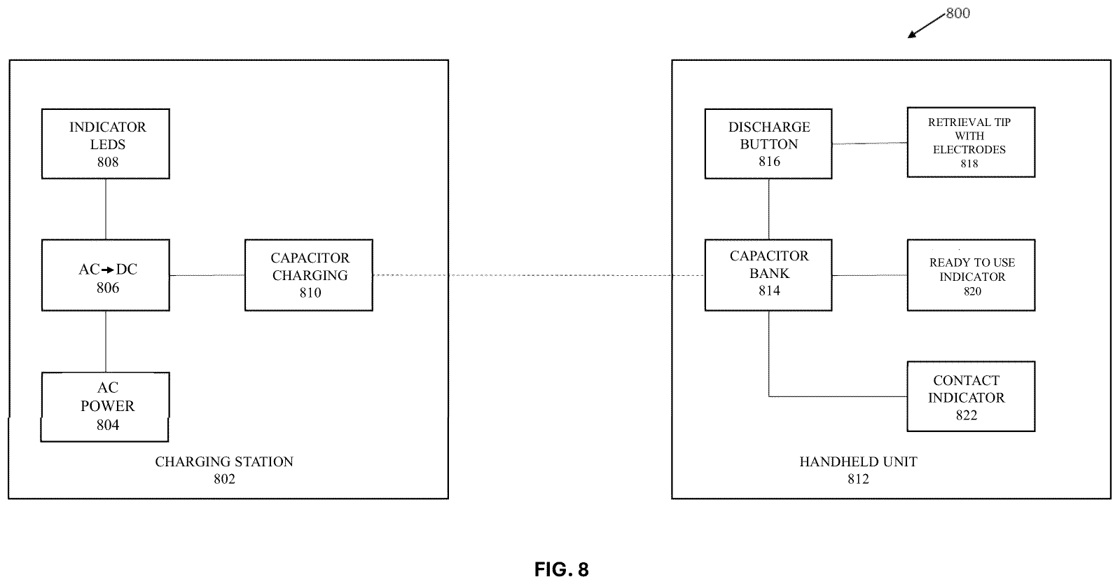

FIG. 8 is a block diagram depicting function components of a system 800 configured in accordance with the present disclosure. System 800 includes a charging station 802 (e.g., station 602 of FIG. 6), which is configured to charge a handheld device 812 (e.g., device 100 of FIG. 1). Charging station 802 includes an A/C power input 804 configured to connect to a source of electricity. An AC to DC converter 806 is connected to A/C power input 804 and configured to generate a DC power output. That DC output is supplied, in turn, to indicator LEDs 808, which can provide an indication that charging station 802 is powered-up, with a connected handheld device 812 that is currently being charged, or combinations thereof. DC converter 806 is further configured to supply the DC power output to capacitor charging 810, which is configured to charge the capacitor bank 814 (e.g., charge storage device 108) of a connected handheld device 812.

Connected handheld device 812 includes a discharge button 816 (e.g., connected to switch 708 of FIG. 7) that is connected to capacitor bank 814 and retrieval tip 818 (e.g., retrieval tip 120). When discharge button 816 is depressed connected handheld device 812 is configured such that the full electrical potential of capacitor bank 814 is placed across retrieval tip 818 enabling electrical discharge therethrough.

Similarly, capacitor bank 814 is connected to a ready-to-use indicator 820 (e.g., user interface element 724 of FIG. 7) that is configured to generate an output (e.g., via an LED) to indicate that capacitor bank 814 is adequately charged and that connected handheld device 812 is ready for us. Connected handheld device 812 further includes a contact indicator 822 (e.g., user interface element 712 of FIG. 7) that is connected to capacitor bank 814 such that when a metallic object is in proximity to the electrodes of retrieval tip 818 the contact indicator 822 (e.g., an LED) generates an output indicating that retrieval tip 818 is properly positioned in proximity to a metallic object.

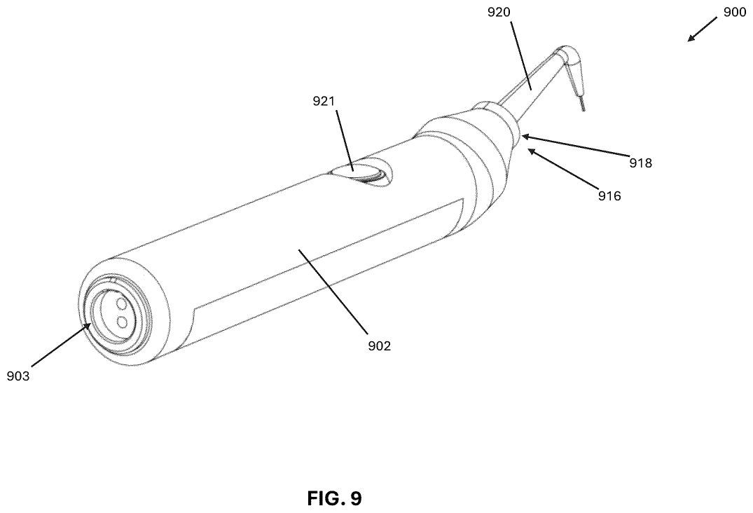

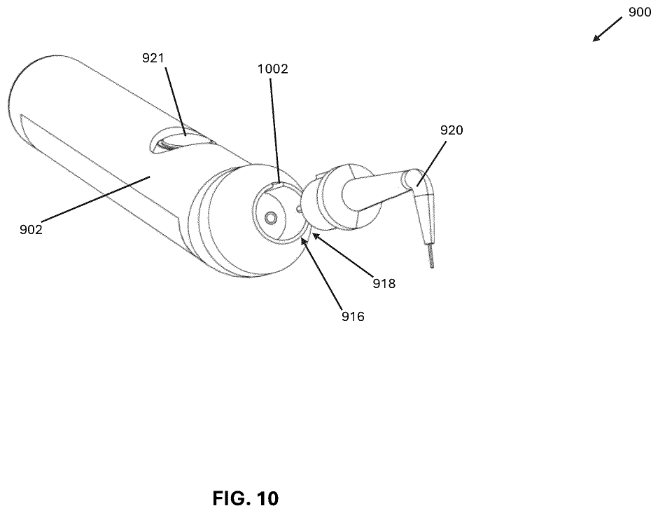

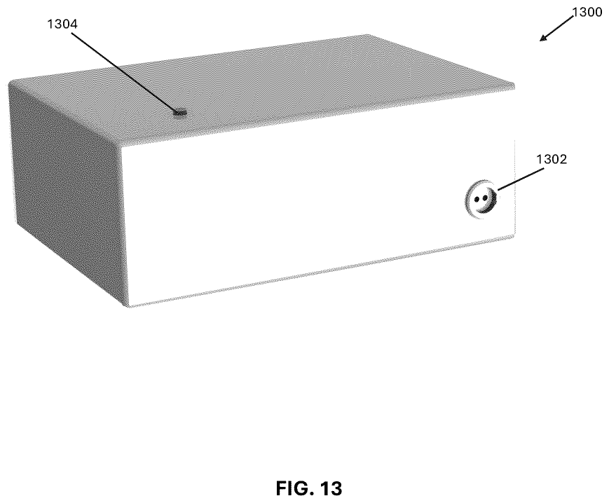

FIGS. 9-10 depict an alternate embodiment of device 900 configured in accordance with the present disclosure. Device 900 includes a housing 902, where housing 902 is configured to enable device 900 to be handheld thereby facilitating operation and positioning of device 900 during a procedure. Device 900 is configured to couple to an electrical power system (e.g., power system 1300 of FIG. 13) at power socket 903.

A distal end 916 of housing 902 of device 900 includes a socket 918 configured to removably couple to retrieval tip 920. The socket 918 can be indexed (e.g., via detent 1002 shown in FIG. 10) to be only capable of receiving retrieval tip 920 in a predetermined and controlled orientation to ensure proper establishment of electrical connections between retrieval tip 920 and socket 918. In an embodiment, device 900 may include a control switch 921 configured to deliver electrical energy from a connected power system into retrieval tip 920.

Using control switch 921, a practitioner can cause the connected power system to deliver an electrical signal to the retrieval tip 920 causing electrical energy to be discharged through the retrieval tip 920 and any metal element thereby. In embodiments, the signal may be a pulse width modulated (PWM) signal having a total time duration of between 1 and 2 seconds (e.g., 1.5 seconds) and frequencies between 100 Hertz and 100 Hertz, for example.

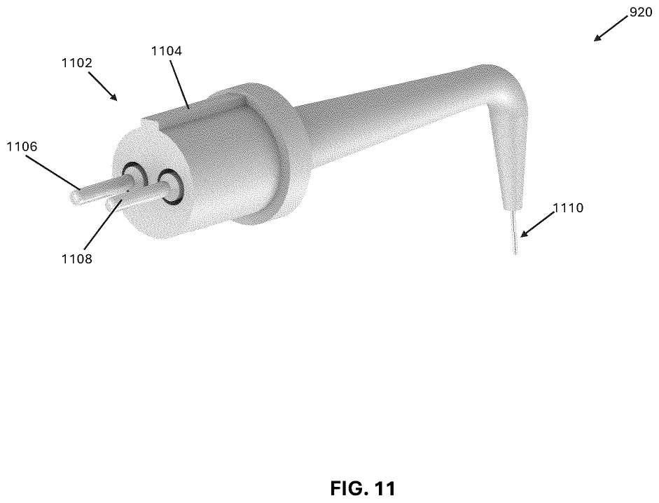

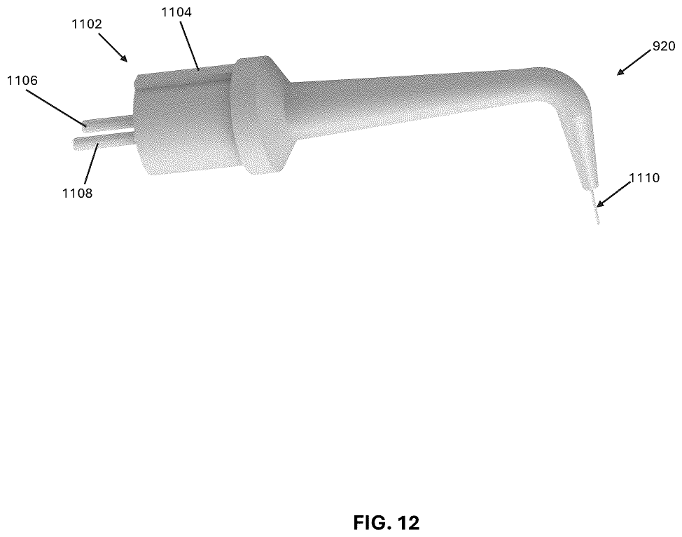

FIGS. 11 and 12 depicts additional detail of retrieval tip 920. Retrieval tip 920 includes socket 1102 configured to couple to socket 918. Alignment key 1104 provides that the orientation of retrieval tip 920 is correct when socket 1102 engages socket 918. Socket 1102 includes contact terminals 1106, 1108. The tip of retrieval tip 920 includes two narrow wires 1110 (e.g., 30AWG) that operate as the anode and cathode of the retrieval tip 920. The wires are insulated from one another by a high temperature and high dielectric piece of silicone rubber (not shown in FIG. 11 or 12). In embodiment two narrow wires 1110 may include a NiTINOL material and be tinned with a low temperature silver to help amalgamate with the NiTiNOL to improve performance.

FIG. 13 depicts an electrical power system 1300 that may be used in conjunction with device 900. Specifically, power system 1300 includes a power output port 1302 configured to be coupled to power socket 903 of device 900 via an electrical cable. Power system 1300 may include one or more user interface elements 1304 enables a user to modify an attribute (e.g., magnitude, pulse duration, frequency, or amperage) of the electrical signal delivered from 1300 to device 900.

In various embodiments, device 900 may have a diameter of around 25 mm and a length of about 200 mm. Two narrow wires 1110 may protrude from 910//by about 2 mm. A length of retrieval tip 920 overall my be about 50 mm.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as connected, although not necessarily directly, and not necessarily mechanically. The terms “a” and “an” are defined as one or more unless stated otherwise. The terms “comprise” and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A device, comprising:
a housing configured to couple to a power system by an electrical wire; and
a retrieval tip, wherein at least a portion of the retrieval tip is configured to be inserted into a hole formed into an interior volume of a tooth, the retrieval tip including:
a first electrode electrically connected to the power system,
a second electrode connected to the power system, and
an insulator disposed between the first electrode and the second electrode, wherein the insulator is configured to inhibit a flow of electricity directly between the first electrode and the second electrode and when a distal end of the retrieval tip is positioned in proximity to a conductive object disposed within the interior volume of the tooth, the power system is configured to deliver an electrical signal of at least 6 volts and 6 amps through the first electrode and the second electrode through the conductive object to cause the conductive object to be affixed to at least one of the first electrode and the second electrode by brazing.

2. The device of claim 1, wherein a width of the retrieval tip through the first electrode and the second electrode is less than 0.6 mm.

3. The device of claim 1, wherein the electrical signal is a pulse width modulation signal having a frequency in a range of 100 Hertz to 200 Hertz and a duration of at least 1.5 seconds.

4. The device of claim 1, wherein at least one of the first electrode and the second electrode includes nickel titanium.

5. The device of claim 1, wherein the conductive object includes at least a portion of dental drill bit or a dental file.

6. The device of claim 1, wherein the insulator includes a varnish material.

7. The device of claim 1, wherein the insulator includes air.

8. The device of claim 1, wherein the retrieval tip includes a hose configured to deliver a shielding gas into the interior volume of the tooth.

9. The device of claim 8, wherein the shielding gas includes Argon (Ar), Carbon Dioxide (CO₂), or a range of a mixture of Ar/CO₂.

10. A retrieval tip configured to be inserted into a hole formed into an interior volume of a tooth, the retrieval tip including:
a first electrode electrically connected to a first terminal of a charge storage device,
a second electrode connected to a second terminal of the charge storage device, and
an insulator disposed between the first electrode and the second electrode, wherein the insulator is configured to inhibit a flow of electricity directly between the first electrode and the second electrode and when a distal end of the retrieval tip is positioned in proximity to a conductive object disposed within the interior volume of the tooth, electrical charge is discharged between the first electrode and the second electrode through the conductive object to cause the conductive object to be affixed to at least one of the first electrode and the second electrode by brazing, wherein the conductive object includes at least a portion of dental drill bit or a dental file.

11. The retrieval tip of claim 10, wherein a width of the retrieval tip through the first electrode and the second electrode is less than 0.6 mm.

12. The retrieval tip of claim 10, wherein the first electrode includes copper and the second electrode includes copper or nickel titanium.

13. The retrieval tip of claim 10, further comprising a hose configured to deliver a shielding gas into the interior volume of the tooth, the shielding gas including Argon (Ar), Carbon Dioxide (CO₂), or a range of a mixture of Ar/CO₂.

14. A method of retrieving a metal object from an interior of a tooth, wherein the metal object is disposed with a channel formed into the tooth, the method comprising:
inserting a retrieval tip into the channel, wherein the retrieval tip includes:
a first electrode electrically connected to a first terminal of a charge storage device,
a second electrode connected to a second terminal of the charge storage device, and
an insulator disposed between the first electrode and the second electrode, wherein the insulator is configured to inhibit a flow of electricity directly between the first electrode and the second electrode;
positioning a distal end of the retrieval tip in proximity to the metal object to cause an electrical charge stored by the charge storage device to be discharged between the first electrode and the second electrode through the metal object to couple the metal object to the first electrode and/or the second electrode; and
withdrawing the retrieval tip and the metal object from the channel.

15. The method of claim 14, wherein a diameter of the first electrode and the second electrode is less than 0.6 mm.

16. The method of claim 14, wherein the first electrode includes copper and the second electrode includes copper.

17. The method of claim 14, wherein the first electrode includes nickel titanium and the second electrode includes copper.

18. The method of claim 14, wherein the charge storage device includes a plurality of capacitors coupled in parallel between a positive terminal of a power source and a negative terminal of the power source.

19. The method of claim 14, wherein the metal object includes at least a portion of dental drill bit or a dental file.

20. The method of claim 14, wherein the first electrode includes nickel titanium and the second electrode includes nickel titanium.
